(19) United States
(12) Patent Application Publication
(10) Pub. No.: US 2011/0283531 A1
(43) Pub. Date: Nov. 24, 2011

(54) Means whereby electricity generated in sources outside of an instrument designed to be powered by an electric cell, can be decivered to said instrument whether or not said cell is encased in said instrument.

(76) Inventor: Dante Carnessale, Ojai, CA (US)

(21) Appl. No.: 13/068,825

(22) Filed: Jul. 15, 2011

Related U.S. Application Data
(60) Provisional application No. 61/396,086, filed on May 20, 2010.

(51) Int. Cl. H01R 43/00

(52) U.S. Cl. 29/825

(57) ABSTRACT

The embodiments specified comprise various devices whereby electricity generated outside of a cell-instrument can be delivered to said instrument's electric circuit directly, or delivered to said circuit through a charged cell encased in said instrument's cell-space.

My specifications emphasize that my devices are, essentially, novel conductors of electricity.

My embodiments provide cheaper, longer-lasting, more available sources of power;

precise, easy control of volume; and
power that can be easily turned on and off during daytime hours, thereby reducing the cost of operating hearing aids.

Hopefully, manufacturers of hearing aids will redesign their instruments so as to offer the public the improvement that I specify in claim 5.

### CROSS-REFERENCE TO RELATED APPLICATIONS

On May 10, 2010, I filed a Provisional patent application—Ser. No. 61/396,086

### FEDERALLY SPONSORED RESEARCH

Not applicable

### SEQUENCE LISTING

Not applicable

### BACKGROUND

1. Field

This application refers to instruments containing a space designed to encase an electric cell.

Hereinafter,

(1) I shall refer to said space as a “cell-space;” and,
(2) I shall refer to said instrument as a “cell-instrument.”

2. Prior Art

The electric cells that power hearing aids provide unsatisfactory service.

For hearing aids, and for other instruments designed to be powered by electric cells,

my invention can provide electric power that:

(a) is longer-lasting; (b) costs less;

(c) can easily be connected or disconnected;

(d) can easily be varied in amperage;

(e) can be purchased in more outlets.

### SUMMARY

I expect that my devices will usually—but not in every case—be transferring electricity at 1.5 volts.

I also expect that the people who use my invention will, in most cases, carry the aforeasid outside sources of electricity in a battery-holder. The 1.5 volt battery-holders are routinely equipped with on-off switches, large-wheeled rheostats (for easy manipulation of amperage), and a stereo connector which is located at the surface of the battery-holder.

Such battery-holders can be suspended from the neck, or carried in a pocket, or clipped to a shirt or blouse.

Such battery-holders can be purchased very cheaply.

### FIRST EMBODIMENT OF MY INVENTION

The positive and negative termini of a cell-instrument protrude into the cell-space. During the time an electric cell (or one of my devices) occupies a cell-space, the termini of said cell (or the termini of my device) will maintain contact with the termini of the instrument. Regarding electric cells: only the flat walls of such cells operate as electric termini.

### DETAILED DESCRIPTION OF FIRST EMBODIMENT OF MY INVENTION

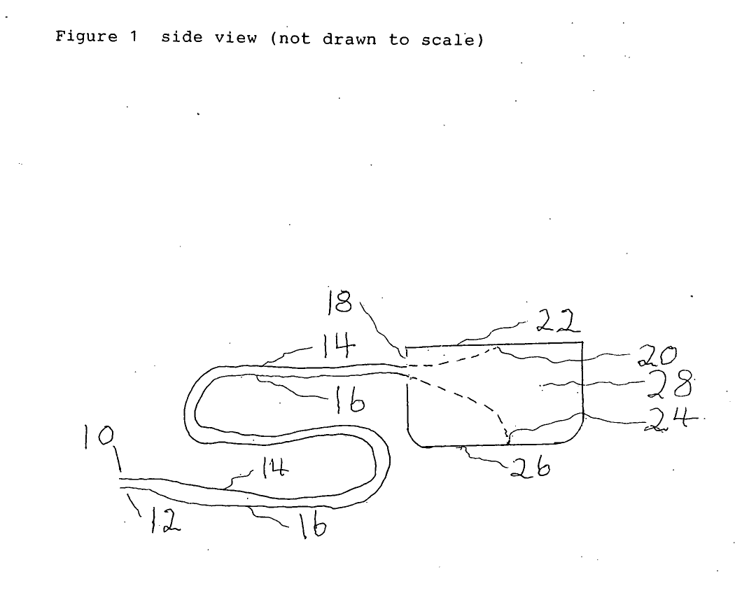

FIG. 1 is a diagram of this embodiment.

A pair of wires: positive wire 14 and negative wire 16, each terminate in the male half of a stereo connector (male stereo half 10 and male stereo half 12).

Male halves 10 and 12 will insert into female stereo halves that are either directly connected to outside sources of electricity, or are connected to such sources by way of an intervening battery-holder circuit.

Wires 14 and 16 enter part 28 at opening 18.

Inside part 28, positive wire 14 is soldered (20) to the inner aspect of the larger flat wall (22) (the positive terminus) of part 28.

Inside part 28, negative wire 16 is soldered (24) to the inner aspect of the smaller flat wall (26) (the negative terminus) of part 2

During all the time that part 28 is located in a cell-space, its positive and negative termini (its two flat walls) will maintain constant contact with the adjacent termini of the cell-instrument.

In hearing aids, a small notch cut into the upper edge of the cell-space door will allow wires to pass from the outside into said cell-space.

### DETAILED DESCRIPTION OF SECOND EMBODIMENT OF MY INVENTION

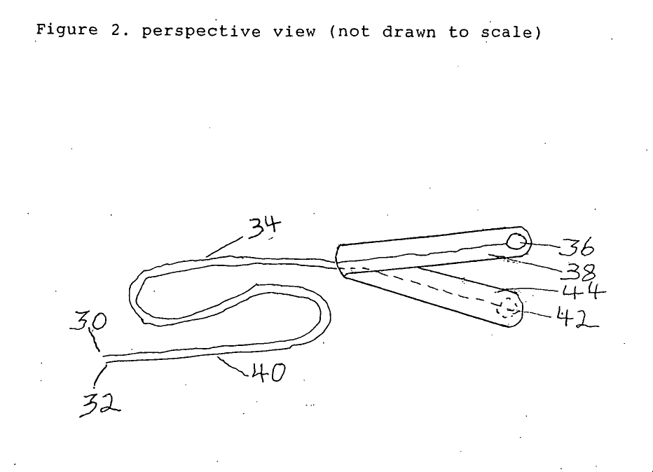

FIG. 2 is a diagram of my second embodiment

In this second embodiment (as in the first embodiment), my device operates by occupying a cell-space that contains no electric cell.

This device can be made of any elastic material.

The device here described is created by folding a strip of elastic material onto itself, thereby forming an elbow and forming two arms diverging from each other.

The material's elastic force acts constantly on said arms, tending to pull them apart from each other.

Unlike the first embodiment device, this device is flexible—not rigid.

This device is designed so that, in its resting state (when the anti-elastic force balances the elastic force) the copper discs stay apart by a distance larger than the distance separating the termini of the instrument. Hence, said arms need to be squeezed together in order for the copper discs on the arms to fit between the instrument's termini. Unsqueezing said arms after insertion, allows said elastic force to constantly push each copper disc against the adjacent terminus of the instrument (i.e., said elastic force is trying to return the arms to their resting state: their distance apart when not squeezed). thereby assuring constant electrical contacts; and assuring that said device will not fall out of the cell-space. While the arms of the device are located within a cell-space, the door to such cell-space may have to remain open. If so, said open door will impede neither the operation of the device nor the operation of the instrument.

Wire 34 ends in the a male half (30) of a stereo connector. Wire 40 ends in the male half (32) of a stereo connector. Positive wire 34 attaches to one or more sources of electricity, attaches to copper disc 36, and both wire and disc are affixed to the outer surface of arm 38. Negative wire 40 attaches to one or more sources of electricity, attaches to copper disc 42, and both wire and disc are affixed to the outer surface of arm 44.

### DETAILED DESCRIPTION OF THIRD EMBODIMENT OF MY INVENTION

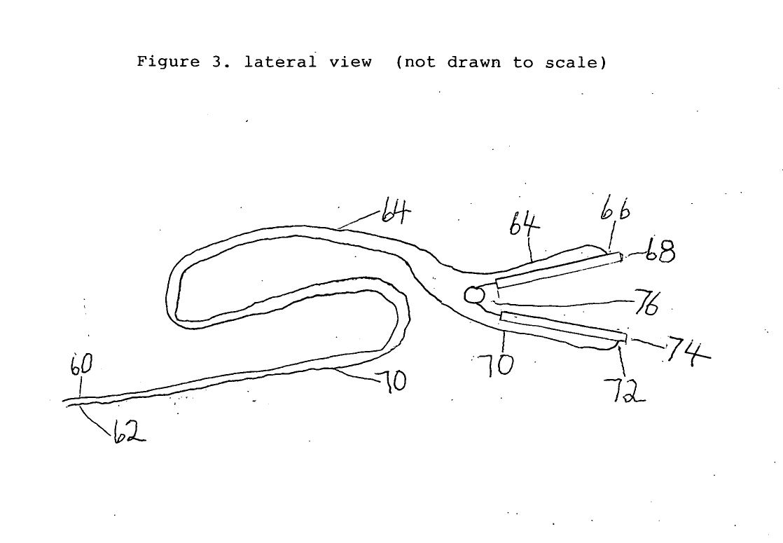

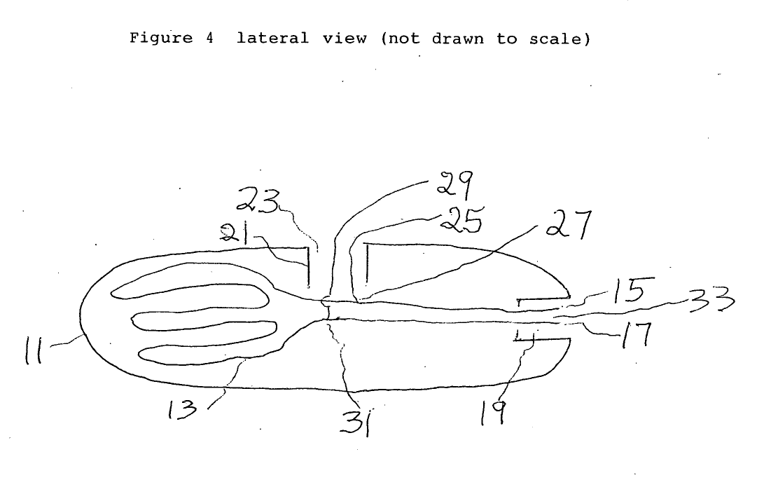

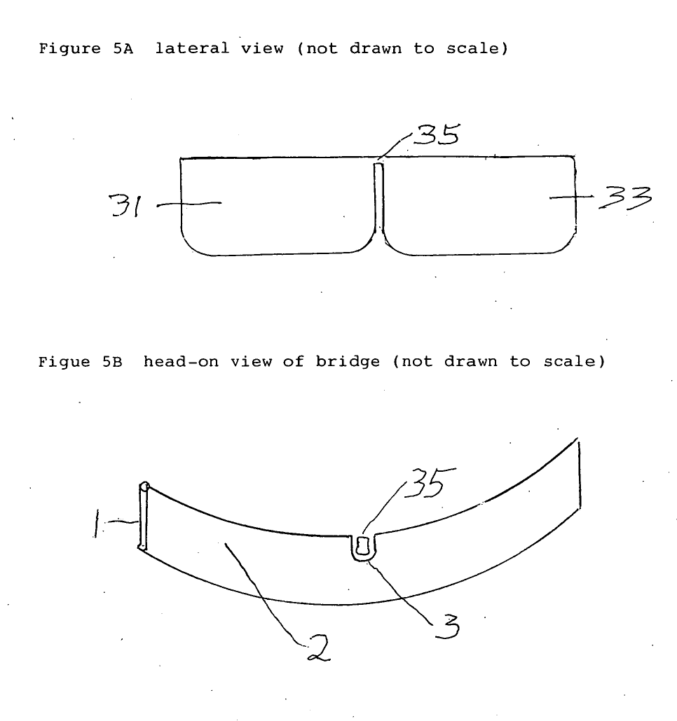

FIG. 3 is a diagram of this embodiment.

The physical structure of the devices of this embodiment is similar to that of the devices of the second embodiment: the two arms and the elbow are present.

But said two arms are not one piece, but two pieces.

At the elbow, the arms are attached to a spring

As is the case with the second embodiment device, said arms, during the time they are not being handled, are kept apart from each other at a constant resting distance by the spring's elasticity. Hence, to introduce this embodiment into a cell-space, it must be squeezed and unsqueezed, in the same way as I explained above for embodiment 2. Obviously, said squeezing and unsqueezing does not necessarily have to be done by thumb and forefinger: the arms of the embodiments can be moved by any of a variety of fulcra and levers.

60 and 62 are the male halves of stereo connectors. Positive wire 64 is attached to copper disc 66, and both are attached to the outer surface of arm 68. Negative wire 70 is attached to copper disc 72, and both are attached to the outer surface of arm 74. The spring is closely affixed to both arms at the elbow of the device.

### A Possible Future Use of My Invention

I believe that, eventually, hearing aids will be re-designed by their manufacturers so as to provide their users with the benefits of this invention. In order for this embodiment of my invention to be realized, an instrument such as a hearing aid has to be re-designed by its manufacturer.

The needed modifications could include the following: the female half of a tiny stereo connector would be affixed to some part of the surface of the aid.

The positive and negative wires inside of said female stereo half would be steered toward—and soldered to—the wires of the instrument which wires travel to—and activate—the instrument's two termini.

This connection between the termini in the cell-space and the female stereo connector could be accomplished, I believe, without any encroachment upon the cell-space. The modifications of the cell-instrument's circuit that I here predict would give the hearing-aid user the following options:
(1) to power his hearing aid via his electric cell; or,
(2) to power his hearing aid by way of outside sources of electricity.

1. A method of connecting the circuit of a cell-instrument to outside sources of electricity by using any of various devices that are embodiments of my invention.

2. The first embodiment of my invention that is referred to in claim 1 comprises: rigid three-dimensional devices, each having the size and shape needed in order to fit exactly into the particular cell-space into which it is inserted.

3. The second embodiment of my invention that is referred to in claim 1 comprises: a flexible device formed by a strip of elastic material bent upon itself so as to form an elbow, and two electricity-carrying arms which, when squeezed together, can be inserted into a cell-space.

4. The third embodiment of my invention that is referred to in claim 1 comprises: a flexible device having two separate arms attached to a coil spring, said arms being electricity-carriers that can be squeezed together, and thereby inserted into a cell-space.

5. The fourth embodiment of my invention that is referred to in claim 1 comprises: a tiny stereo connector, whose female half will be permanently fixed into the surface of a cell-instrument, and whose wires will be soldered to the same termini of said instrument that would be contacted by the flat conductive surfaces of an electric-cell.

6. The sixth embodiment of my invention that is referred to in claim 1 comprises:
two or more fully-charged electric cells rigidly attached to each other by a tiny rigid tube, or semi-rigidly attached by stiff wires, whereby the milliamp-hour reserve of any such combinations of cells will be a multiple of the milliamp-hour reserve of an individual cell.
